(19) United States
(12) Patent Application Publication
(10) Pub. No.: US 2007/0054099 A1
(43) Pub. Date: Mar. 8, 2007

(54) DVD case interior panel insert, and related method

(76) Inventor: Richard Mitchell Fry, Olney, MD (US)

Correspondence Address: Richard M. Fry, 18208 Fountain Grove Way, Olney, MD, 20832, US

(21) Appl. No.: 11/218,497

(22) Filed: Sep. 6, 2005

(51) Int. Cl. B41M 3/10

(52) U.S. Cl. 428/211.1

(57) ABSTRACT

A DVD case interior panel insert printable sheet suitable for use in the production of a DVD insert is provided. The printable sheet has a peripheral edge with a length of 14 inches, and a defined pattern of reduced strength inside the peripheral edge. The defined pattern and peripheral edge collectively establish three contiguous rectangular patterns each having a width of 4.66 inches to define three DVD case interior panel insert leafs suitable for fitting against a panel inner surface of an industry standard DVD case. Preferably, the DVD case interior panel insert printable sheet is United States standard Legal Size paper. Methods of making the DVD case interior panel insert and inserting the same inside a DVD case are also provided.

### FIELD OF THE INVENTION

This invention relates to panel inserts suitable for use in digital video disc (“DVD”) case interiors, printable sheets for making the panel inserts, and to methods for making and using the panel inserts.

### BACKGROUND OF THE INVENTION

Digital Video Discs (or DVDs) are part of a recent generation of optical disc storage technology that allows for the storage of a large volume of information in a compact medium. In many ways, DVD technology is superior to its videotape and compact disc (or “CD”) predecessors. DVDs are more durable than videotapes. DVDs can also hold more information than videotapes and compact discs, making DVDs more suitable for storage of both video and audio information. As a result, DVDs have gained wide and still growing acceptance in various industries, including, for example, the motion picture, video game, and computer software industries.

Due to the somewhat fragile nature of DVDs, which are susceptible to scratching and breakage, it is standard industry practice to sell, transport, and store DVDs in protective cases. There are industry standard dimensions for DVD cases. Generally, a DVD case comprises front and rear panel faces measuring approximately 7.5 inches (190.5 mm)×approximately 5.25 inches (133.35 mm), and a spine measuring about 7.5 inches (190.5 mm)×approximately 9/16 inches (14.3 mm);

In order to identify the contents of the DVD inside the case (without opening the case) and entice consumers into purchasing the DVD, it also is industry practice to adorn the panel outer faces of the DVD protective case with an identification cover insert. The cover insert typically is made of a suitable printable media, such as a paper sheet or the like, onto which a layout comprising the identifying information and optionally decorations is printed.

Within the DVD case compartment, either one case interior panel insert is attached to a panel inner face, or first and second interior panel inserts are attached to opposite panel inner faces, respectively. Typically, literature regarding the product and/or DVD contents is printed on the interior panel insert. Such literature may include, for example, a response or registration card, instructions, photos, graphics, advertising, or information concerning the DVD contents, such as a table of contents, special feature listings and descriptions, cast and credit information, and song lyrics. Similar to the cover insert, the interior panel insert typically is made of a suitable printable media, such as a paper sheet or the like. The DVD case interior panel insert may contain a single leaf of paper or multiple leafs. The multiple leafs may be separate from one another or joined together in a leaflet or booklet. Each leaf may have literature or other print material on one side (i.e., one page) or both of its sides (i.e., two pages).

The industry standard dimensions of a DVD case interior panel insert leaf are approximately 4.66 inches (118.53 mm)×approximately 7.125 inches (180.98 mm). Production of DVD case interior panel inserts generally involves printing two panel insert leafs side-by-side on a single piece of standard-sized paper. The combined print length of two panel insert leafs is twice that of a single leaf, i.e., two times 4.66 inches, or approximately 9.33 inches (237.07 mm). Therefore, the two side-by-side leafs take up an area of approximately 9.33 inches (237.07 mm)×approximately 7.125 inches (180.98 mm). These dimensions are smaller than those of standard letter size 11 inches (279.4 mm)×8½ inches (215.9 mm) paper. To address this size difference, DVD case interior panel inserts are manufactured using standard letter size paper having perforations that define a pattern corresponding to the perimeters of two industry standard size panel insert leafs. The perforated pattern is centered on the standard letter size paper to provide border portions at the sides, top and bottom of the perforated pattern. The border portions are detached from the panel insert leafs after printing, and are treated as waste. The amount of waste paper per DVD case is relatively small in view of the relative close correspondence between the dimensions of standard paper and a pair of DVD case interior panel inserts. As a consequence, standard size paper is widely favored as the stock of choice for making DVD case interior panel inserts.

Detachment of excess border portions at all four edges of the printed interior panel insert leafs is laborious and time consuming, thereby deleteriously affecting production costs. Further, while the amount of waste paper from the border portions is relatively small for a single sheet, the total amount of waste for a large production facility can amass into significant amounts, leading to processing inefficiencies and disposal problems.

### SUMMARY OF THE INVENTION

It is therefore an object of the present invention to provide a DVD case interior panel insert printable sheet and a method of printing on the sheet which reduce the quantity of waste border paper.

It is another object of the present invention to provide a DVD case interior panel insert printable sheet and a method that take advantage of standard size stock paper, especially United States standard Legal Size paper.

In accordance with the purposes of the invention as embodied and broadly described herein, a first aspect of the invention provides a DVD case interior panel insert printable sheet having a peripheral edge with a length of 14 inches. The printable sheet further has a defined pattern of reduced strength inside the peripheral edge. The defined pattern and peripheral edge collectively establish three contiguous DVD case interior panel insert leafs each having a width of 4.66 inches for fitting against a panel inner surface of an industry standard DVD case.

A second aspect of the invention provides a method of making a DVD case interior panel insert. The method comprises providing a DVD case interior panel insert printable sheet having a peripheral edge with a length of 14 inches, and a defined pattern of reduced strength inside the peripheral edge. The defined pattern and peripheral edge collectively establish three contiguous DVD case interior panel insert leafs each having a width of 4.66 inches for fitting against an inner panel surface of an industry standard DVD case. An image is printed on at least one side of the DVD case interior panel insert printable sheet.

According to a third aspect of the invention, a method is provided for inserting a panel insert into the interior compartment of a DVD case. The method of this third aspect comprises providing a DVD case having at least one panel with an inner surface, and providing a DVD case interior panel insert printable sheet having a peripheral edge with a length of 14 inches, and a defined pattern of reduced strength inside the peripheral edge. The defined pattern and peripheral edge collectively establish three contiguous DVD case interior panel insert leafs each having a width of 4.66 inches for fitting against the inner panel surface of an industry standard DVD case. The DVD case interior panel insert leafs are separated and/or folded relative to one another along the defined pattern. Then at least one of the DVD case interior panel insert leafs is inserted into the DVD case and fastened to the panel inner surface.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 shows a DVD case interior panel insert printable sheet according to a first embodiment of the invention;

FIG. 2 shows a DVD case interior panel insert printable sheet according to a second embodiment of the invention;

FIG. 3 shows a DVD case interior panel insert printable sheet according to a third embodiment of the invention;

FIG. 4 shows the inside of a DVD case, including a DVD case interior panel insert made from the printable sheet of FIG. 1, 2 or 3; and

FIG. 5 shows the inside of a multi-disc DVD case, including front and rear panel inserts made from the printable sheets of FIG. 1, 2 or 3.

### DETAILED DESCRIPTION OF PREFERRED EMBODIMENTS AND METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

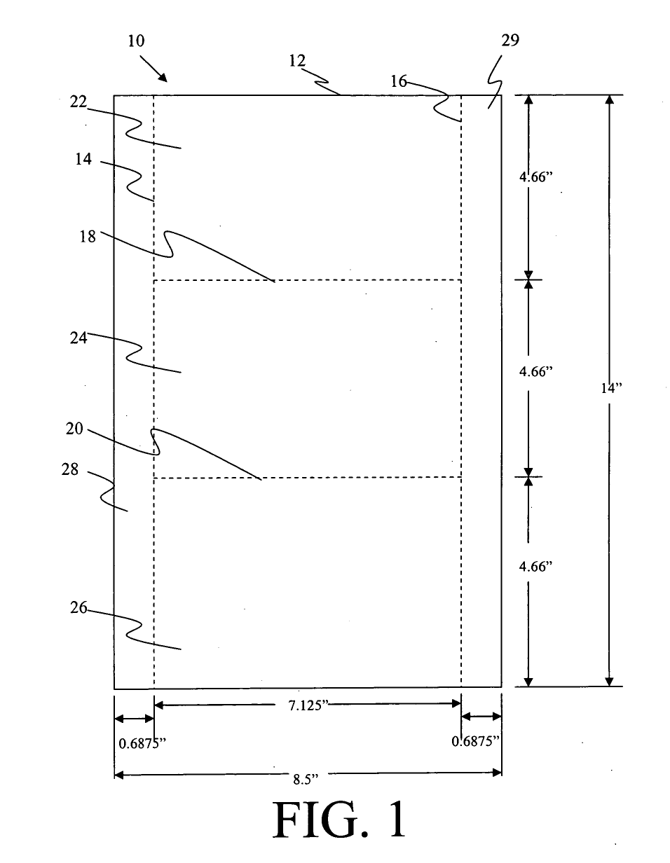

Referring now more particularly to the drawings, there is shown in FIG. 1 a DVD case interior panel insert printable sheet generally designated by reference numeral 10. Generally, the sheet 10 may comprise paper, although other forms and materials of printable media having a sheet-like appearance may be used. The sheet 10 has a peripheral edge 12 in the shape of a rectangle. Preferably, the sheet is stock size paper having a length of 14 inches, and a width of 8.5 inches.

Situated within the peripheral edge 12 is defined pattern of reduced strength. In FIG. 1, the defined pattern includes parallel lengthwise perforations 14, 16 extending from the bottom to the top of peripheral edge 12. Peripheral edge 12 and lengthwise perforation 14 collectively define a rectangular first margin portion 28 extending from the top to bottom of left side of sheet 10. Peripheral edge 12 and lengthwise perforation 16 likewise collectively define a rectangular second margin portion 29 extending from the top to bottom of the right side of sheet 10.

The defined pattern of FIG. 1 further includes a pair of parallel widthwise perforations 18, 20 depicted extending between lengthwise perforations 14, 16, although it should be understood that perforations 18, 20 may extend to the opposite sides of edge 12. Preferably, perforations 18, 20 divide the length of sheet 10 into equal thirds. Peripheral edge 12, lengthwise perforations 14, 16, and widthwise perforation 18 collectively define edges of a top rectangular DVD case interior panel insert leaf 22. Lengthwise perforations 14, 16, and widthwise perforations 18, 20 collective define edges of a middle rectangular DVD case interior panel insert leaf 24. Peripheral edge 12, lengthwise perforations 18, 20, and widthwise perforation 20 collectively define edges of a bottom rectangular DVD case interior panel insert leaf 26. Leafs 22, 24 are contiguous with one another, and leafs 24, 26 are contiguous with one another.

The defined pattern established by perforations 14, 16, 18, 20 preferably has sufficiently reduced strength to permit a user to successfully and cleanly separate the leafs 22, 24, 26 from one another and from margin portions 28, 29 by manual tearing, preferably without the use of cutting instruments such as scissors. On the other hand, the defined pattern preferably has adequate strength to endure (without tearing) at least one printing cycle through a known printing device, such as an inkjet or laser printer. The defined pattern of reduced strength preferably comprises a continuous perforation or the like. Techniques for forming perforations and the like in a sheet are well known in the art, e.g., a perforation die, and, therefore, are not described in further detail herein.

At least one, and more preferably each of leafs 22, 24, 26 has a height of approximately 4.66 inches. In FIG. 1, the lengthwise perforations 14, 16 are spaced approximately 0.6875 inches from their respective proximal edges. For the 8.5 inch wide paper 10 of FIG. 1, the space remaining between perforations 14, 16 is 7.125 inches. Hence, in FIG. 1 each of DVD case interior panel insert leafs 22, 24, 26 have rectangular dimensions of approximately 4.66″×approximately 7.125″. These dimensions correspond exactly to those of industry standard-size DVD case interior panel insert inserts. No border paper is wasted above leaf 22 or below leaf 26.

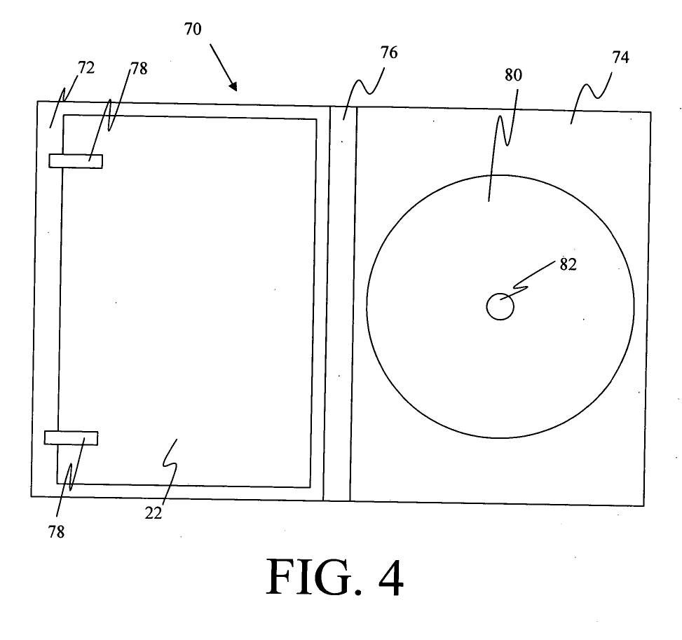

A single leaf, e.g., leaf 22 as shown in FIG. 4 discussed below, may be used alone as the interior panel insert of a DVD case. Alternatively, two, three, or more leafs 22, 24, 26 may be used together as the panel insert of a DVD case. In the latter instance, leafs 22, 24, and/or 26 optionally may be attached together to form a leaflet or booklet. Each leaf may be printed on one side (i.e., one page) or both sides (i.e., two pages).

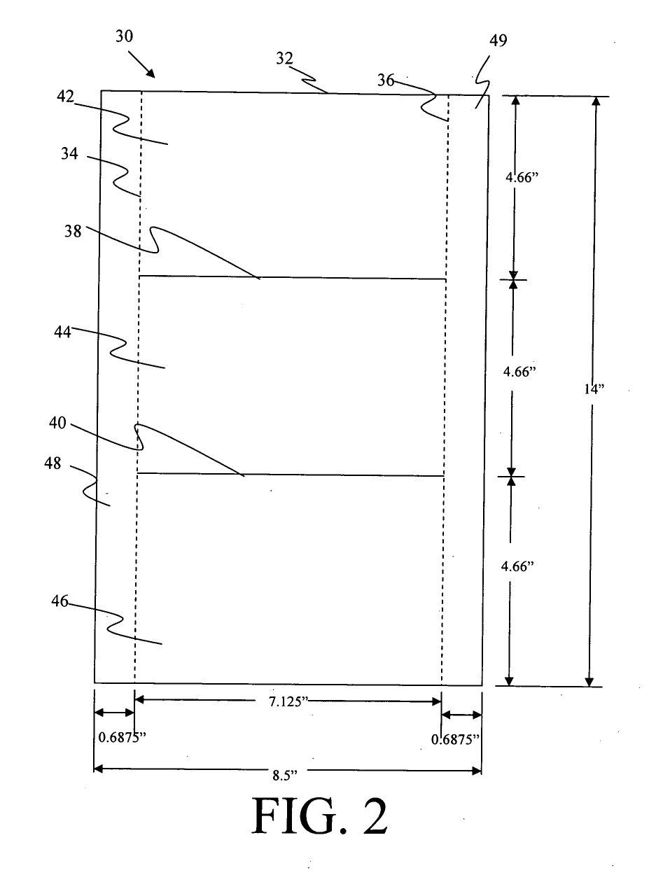

DVD case interior panel insert printable sheet 30 of FIG. 2 departs from that of FIG. 1 in that the defined pattern of FIG. 2 includes parallel widthwise scored lines 38, 40 in place of perforations 18, 20 of FIG. 1. Scored lines 38, 40 are spaced approximately 4.66 inches from the top and bottom, respectively, of perimeter 32, dividing sheet 30 into three identical sized leafs 42, 44, 46. Scored lines 38, 40 preferably do not include perforations extending through the entire thickness of sheet 30. Scored line 38 facilitates folding between leafs 42 and leaf 44 to form a crease while maintaining attachment between leafs 42, 44. Similarly, scored line 40 facilitates folding between leaf 44 and leaf 46 to form a crease while maintaining attachment between leafs 44, 46. Side margin portions 48, 49 are detachable along lengthwise perforations 34, 36. Leafs 42, 44, 46 may be folded together in accordion style or menu style (i.e., leafs 42 and 46 folded onto leaf 44) to form a leaflet for use as an interior panel insert of a DVD case.

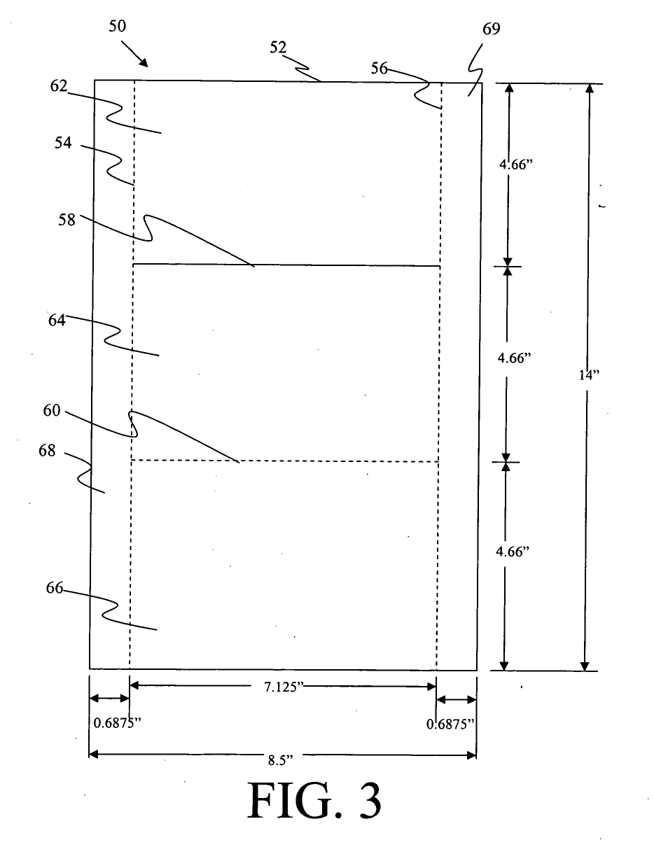

FIG. 3 depicts a third embodiment of a DVD case interior panel insert printable sheet 50 which departs from the embodiments of FIGS. 1 and 2 in that the defined pattern of FIG. 3 includes a widthwise scored line 58 and a parallel widthwise perforation 60. Scored line 58 and perforation 60 are each spaced approximately 4.66 inches from the top and bottom, respectively, of perimeter 52, dividing sheet 50 into three identical sized leafs 62, 64, 66. Scored line 58 facilitates folding between leafs 62 and 64 while maintaining attachment between leafs 62, 64. Perforation 60 facilitates detachment of leaf 64 from leaf 66. Lengthwise perforations 54, 56 facilitate delineation and detachment of side margin portions 68, 69. This embodiment lends itself to the production of various types of DVD case interior panel inserts. For example, leaf 66 may be detached, leaving leafs 62, 64 to form a leaflet creased along scored line 58. Multiple leaflets may be bound together to form a booklet. It is also possible to retain leaf 66 attached to leaf 64. For example, leaf 66 may constitute a response or product registration card, which the consumer can remove from the DVD case, tear along perforation 60, and mail to supplier complete with his or her personal information for registration.

It should be understood that the features of the above embodiments may be practiced together in various combinations. It should also be understood that various departures to the embodiments described above have been contemplated, including but not limited to the following. The distance between lengthwise perforations (e.g., 14, 16) may be varied as desired to alter the width of leafs (e.g., 22, 24, 26), for example but not necessarily limitation, in a range of 6.75 inches to 7.25 inches. Also, although margin portions (e.g., 28, 30) have been illustrated as having widths (measured from lengthwise perforations 14, 16 to perimeter 12) identical to one another, optionally these widths may be unequal to one another. It is also possible to eliminate either of margin portions (e.g., 28, 29), for example, by doubling the width of the other margin portion. Further, different width sheets 10, 30, 50 than standard Legal Size paper may be used, although it is preferred to employ a sheet having a length of 14.0 inches.

A method of making and using a DVD case interior panel insert will now be described in further detail. The method comprises providing a DVD case interior panel insert printable sheet as embodied herein. Images, such as information or decorations, are printed on the sheet using a suitable printing device, such as an ink jet printer or a laser printer. The same or different images may be printed on the three leafs, e.g., 22, 24, 26, on a single sheet 10. Further, images may be printed on either one side (i.e., a single page) or both sides (i.e., two pages) of a single sheet 10. Printing may be performed using appropriate commercially available software. Many major software programs, including Microsoft Word, are compatible with and pre-programmed for print selecting the United States Legal Size (8½″×14″) format. Further, the Legal Size format is compatible with paper feed trays found in many laser and inkjet printers sold in the United States. For these and other reasons (e.g., reduction of paper waste and less laborious processing) discussed herein, Legal Size paper is preferred in practicing this embodiment of the invention. The color of the paper is not particularly limited, although according to one current embodiment bright white, 67 lb matte vellum paper is used.

Printing preferably comprises a selective positioning step for placing the image (e.g., information and/or decoration) to be printed in the defined pattern. The image optionally may bleed over the defined pattern and into margin portions, e.g., 28, 29, in order to reduce or eliminate the unprinted areas along the side edge or edges of the DVD case interior panel insert. The margin portions are typically white, although the particular color will depend on the color of the selected printable sheet. In the case that bleed over is desired, the printed image is preferably wider, but not higher, in dimension than leafs 22, 24, 26. Alternatively, the printed image may be sized equal to the leaf dimensions.

After printing, the margin portions, e.g., 28, 29 are separated from leafs, e.g., 22, 24, 26 of printable sheet 10. Bleed printed images are effectively cropped. Further, margin portions, e.g., 28, 29 are sufficient in size to facilitate ease of their removal, e.g., by grabbing with one's fingers and ripping from leafs 22, 24, 26. It should be apparent that features referred to as the “sides” of the printable sheet leafs become the top and bottom of leafs as inserted into a DVD case. Likewise, the “bottom” and “top” of the printable sheet leafs become the sides of the leafs when inserted into a DVD case.

FIG. 4 depicts DVD case 70 having front panel 72 and rear panel 74. Spine 76 connects panels 72, 74, and allows folding of panels 72, 74 over one another between an open state, in which the DVD may be removed or returned into the DVD compartment, and a closed state, in which the DVD compartment is inaccessible. Rear panel 74 includes a circular groove 80 and center retaining member 82 for receiving and securing a DVD (not shown). Front panel 72 has a pair of resilient clips 78 each integrally connected at one of its ends, i.e., the left ends in FIG. 4, to panel 72. The opposite ends, i.e., right ends in FIG. 4, of clips 78 are free, but preferably urged downward for applying a retaining force. A DVD case interior panel insert, such as leaf 22, is slid under and secured in place by the free ends of clips 78. Preferably, clips 58 permit the consumer to remove leaf 22 from panel 72 for viewing. Although FIG. 4 illustrates DVD case interior panel insert as a single leaf 22, it should be understood that the DVD case interior panel insert may comprise, for example, multiple distinct leafs (e.g., 22, 24, 26) bound or unbound, a leaflet of two or three attached leafs (e.g., 42, 44) creased along a score line (e.g., 38), a booklet of multiple leaflets bound along a spine using a staple or adhesive, and/or detachable leafs, e.g., 66.

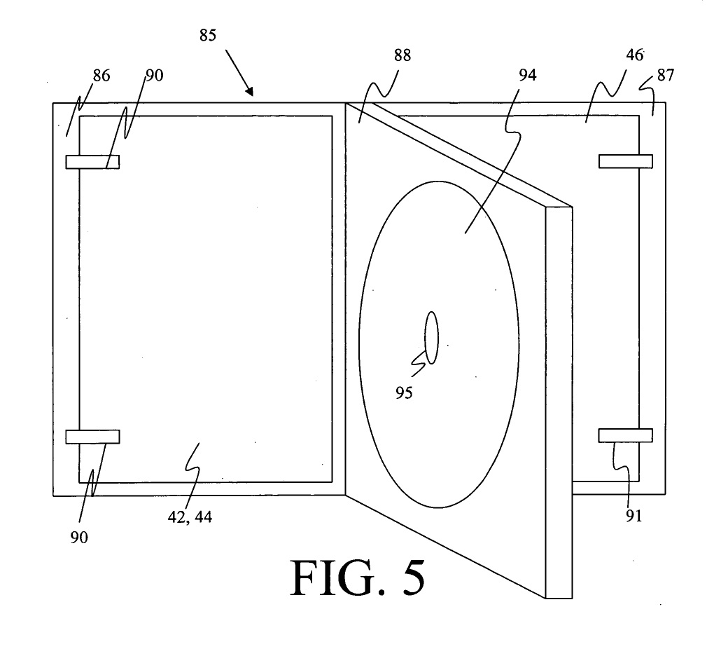

FIG. 5 depicts a DVD case 85 comprising a front panel 86, a rear panel 87, and an intermediate panel 88. Front panel 86 includes clips 90 for retaining a DVD case interior panel insert, such as a leaflet composed of leafs 42, 44. Rear panel 87 includes its own set of clips 91 for retaining a DVD case interior panel insert, such as leaf 46. Intermediate panel 88 includes a front surface with circular groove 94 and circular retaining member 95 for retaining a first DVD. Although not shown, the opposite side of intermediate panel 88 may have another circular groove and retaining member for retaining a second DVD. More than one intermediate panel 88 may be provided for storing additional DVDs.

From the above, it will become apparent that embodiments of the invention as described herein may provide one or more of the following advantages.

First, the use of standard United States Legal Size 8½″×14″ paper format makes certain embodiment of the invention particularly compatible with various commercially available software programs and printers.

Second, the elimination of border portions at the top and bottom of the printable sheet reduces the amount of waste produced in production of the DVD case interior panel insert. The elimination of top and bottom borders also avoids the laborious processing steps of removing these border portions, thus improving processing efficiency and lowering production costs.

Third, retaining side margin portions permits bleeding over of the printed image, thereby improving print quality at the sides of the printed DVD case interior panel insert. Further, these margin portions are sufficiently large in size to facilitate processing. For example, it is generally easier to grip, e.g., with fingers, the margin portions of embodiments of the invention for tearing along the defined pattern of reduced strength and for discarding margin portion waste.

Another advantage particularly applicable to embodiments selecting the United States Legal Size paper format relates to storage and filing. Many folders, cabinets, boxes, and cartons are specifically designed for holding legal size documents.

Certain embodiments of the invention which make use of United States Legal Size paper format are especially advantageous when used in the context of custom printing processes. Custom printing of DVD case interior panel inserts often involves commercial offset printing a company's logo and contact information on a blank sheet, then adding photos, graphics, and/or program or data information at a later date by running the sheet through a computer printer; Commercial offset printing is typically performed in presses set up in advance to handle either United States Letter Size paper format or United States Legal Size paper format to expedite processing. A relatively small number, if any, of printers in the United States remains set up in the normal course of operation for handling A4 paper. There is a cost involved with resetting a press to handle a size such as A4. There is also an issue of A4 paper availability. These costs and issues are avoided when using United States Legal Size paper format.

Additional advantages and modifications will readily occur to those skilled in the art upon reference to this disclosure. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A DVD case interior panel insert printable sheet having a peripheral edge with a length of 14 inches, and a defined pattern of reduced strength inside the peripheral edge, the defined pattern and peripheral edge collectively establishing three contiguous DVD case interior panel insert leafs each having a width of 4.66 inches for fitting against a panel inner surface of an industry standard DVD case.

2. A DVD case interior panel insert printable sheet according to claim 1, wherein the printable sheet comprises paper.

3. A DVD case interior panel insert printable sheet according to claim 2, wherein the paper comprises a stock sheet of Legal Size paper having rectangular dimensions of 8.5 inches by 14 inches.

4. A DVD case interior panel insert printable sheet according to claim 1, wherein the defined pattern comprises at least one perforation at an interface of the DVD case interior panel insert leafs for facilitating separation of the DVD case interior panel insert leafs from one another.

5. A DVD case interior panel insert printable sheet according to claim 1, wherein the defined pattern comprises at least one score at an interface of the DVD case interior panel insert leafs for facilitating folding of the DVD case interior panel insert leafs upon one another and establishing a crease along the score.

6. A DVD case interior panel insert printable sheet according to claim 1, wherein the defined pattern comprises parallel lengthwise perforations spaced apart from one another by approximately 6.75 inches to approximately 7.25 inches for delineating side margin portions on opposite sides of the DVD case interior panel insert leafs and for facilitating separation of the side margin portions from the DVD case interior panel insert leafs.

7. A DVD case interior panel insert printable sheet according to claim 1, wherein the defined pattern comprises parallel lengthwise perforations spaced apart from one another by approximately 7.125 inches for delineating side margin portions on opposite sides of the DVD case interior panel insert leafs and for facilitating separation of the side margin portions from the DVD case interior panel insert leafs.

8. A DVD case interior panel insert printable sheet according to claim 1, further comprising an image printed on each of the DVD case interior panel insert leafs.

9. A DVD case interior panel insert printable sheet according to claim 1, wherein:
the printable sheet comprises a stock sheet of Legal Size paper having rectangular dimensions of 8.5 inches by 14 inches;
the defined pattern comprises at least one perforation at an interface of the DVD case interior panel insert leafs for facilitating separation of the DVD case interior panel insert leafs from one another; and
the defined pattern further comprises parallel lengthwise perforations spaced apart from one another by approximately 6.75 inches to approximately 7.25 inches for delineating side margin portions on opposite sides of the DVD case interior panel insert leafs and for facilitating separation of the side margin portions from the DVD case interior panel insert leafs.

10. A DVD case interior panel insert printable sheet according to claim 1, wherein:
the printable sheet comprises a stock sheet of Legal Size paper having rectangular dimensions of 8.5 inches by 14 inches;
the defined pattern comprises at least one score at an interface of the DVD case interior panel insert leafs for facilitating folding of the DVD case interior panel insert leafs upon one another and establishing a crease along the score; and
the defined pattern further comprises parallel lengthwise perforations spaced apart from one another by approximately 6.75 inches to approximately 7.25 inches for delineating side margin portions on opposite sides of the DVD case interior panel insert leafs and for facilitating separation of the side margin portions from the DVD case interior panel insert leafs.

11. A method of making a DVD case interior panel insert, comprising:
providing a DVD case interior panel insert printable sheet having a peripheral edge with a length of 14 inches, and a defined pattern of reduced strength inside the peripheral edge, the defined pattern and peripheral edge collectively establishing three contiguous DVD case interior panel insert leafs each having a width of 4.66 inches for fitting against a panel inner surface of an industry standard DVD case; and
printing an image on at least one side of the DVD case interior panel insert printable sheet.

12. A method according to claim 11, wherein the printable sheet comprises paper.

13. A method according to claim 12, wherein the paper comprises a stock sheet of Legal Size paper having rectangular dimensions of 8.5 inches by 14 inches.

14. A method according to claim 11, wherein the defined pattern comprises at least one perforation at an interface of the DVD case interior panel insert leafs, and wherein the method further comprises separating the DVD case interior panel insert leafs from one another along the perforation.

15. A method according to claim 11, wherein the defined pattern comprises at least one score at an interface of the DVD case interior panel insert leafs, and wherein the method further comprises folding the DVD case interior panel insert leafs upon one another at the score to establish a crease.

16. A method according to claim 11, wherein the defined pattern comprises parallel lengthwise perforations spaced apart from one another by approximately 6.75 inches to approximately 7.25 inches for delineating side margin portions on opposite sides of the DVD case interior panel insert leafs, and wherein the method further comprises separating the side margin portions from the DVD case interior panel insert leafs along the parallel lengthwise perforations.

17. A method according to claim 11, wherein the defined pattern comprises parallel lengthwise perforations spaced apart from one another by approximately 7.125 inches for delineating side margin portions on opposite sides of the DVD case interior panel insert leafs, and wherein the method further comprises separating the side margin portions from the DVD case interior panel insert leafs along the parallel lengthwise perforations.

18. A method according to claim 11, wherein:
the printable sheet comprises a stock sheet of Legal Size paper having rectangular dimensions of 8.5 inches by 14 inches, and the defined pattern comprises at least one perforation at an interface of the DVD case interior panel insert leafs, and parallel lengthwise perforations spaced apart from one another by approximately 6.75 inches to approximately 7.25 inches for delineating side margin portions on opposite sides of the DVD case interior panel insert leafs;
separating the side margin portions from the DVD case interior panel insert leafs along the parallel lengthwise perforations; and
separating the DVD case interior panel insert leafs from one another along the interface perforation.

19. A method according to claim 11, wherein:
the printable sheet comprises a stock sheet of Legal Size paper having rectangular dimensions of 8.5 inches by 14 inches, and the defined pattern comprises at least one score at an interface of the DVD case interior panel insert leafs, and parallel lengthwise perforations spaced apart from one another by approximately 6.75 inches to approximately 7.25 inches for delineating side margin portions on opposite sides of the DVD case interior panel insert leafs;
separating the side margin portions from the DVD case interior panel insert leafs along the parallel lengthwise perforations; and
folding the DVD case interior panel insert leafs upon one another along the score and establishing a crease.

20. A method of inserting an interior panel insert into a DVD case, comprising:
providing a DVD case comprising at least one panel having an inner surface;
providing a DVD case interior panel insert printable sheet having a peripheral edge with a length of 14 inches, and a defined pattern of reduced strength inside the peripheral edge, the defined pattern and peripheral edge collectively establishing three contiguous DVD case interior panel insert leafs each having a width of 4.66 inches for fitting against a panel inner surface of an industry standard DVD case;
separating, folding, or separating and folding the DVD case interior panel insert leafs relative to one another along the defined pattern; and
inserting at least one of the DVD case interior panel insert leafs into the DVD case and fastening the at least one of the DVD case interior panel insert leafs to the inner surface of the panel.
